(19) United States
(12) Patent Application Publication
(10) Pub. No.: US 2025/0353120 A1
(43) Pub. Date: Nov. 20, 2025

(54) LASER WELDING SYSTEM AND METHOD

(71) Applicant: Honeywell Federal Manufacturing & Technologies, LLC, Kansas City, MO (US)

(72) Inventors: Ryan Shaw, Kansas City, MO (US); Michael Ivey, Kansas City, MO (US)

(21) Appl. No.: 19/210,057

(22) Filed: May 16, 2025

Related U.S. Application Data
(60) Provisional application No. 63/649,523, filed on May 20, 2024.

(51) Int. Cl. B23K 37/04; B23K 26/12; B23K 26/21; B23K 103/12

(52) U.S. Cl. CPC B23K 37/0408; B23K 26/1224; B23K 26/21; B23K 2103/12

(57) ABSTRACT

Systems and methods for welding first and second foils together. A method includes a step of positioning the first and second foils on a lower section of an aluminum fixture. The method further includes a step of compressing the first and second foils together over a first ridge of the lower section via an upper section of the aluminum fixture thereby defining a first weld location coinciding with the first ridge. The method further includes a step of activating a blue or green laser along the first weld location thereby welding the first and second foils together such that the aluminum fixture remains unwelded. Another method includes compressing first and second foils together over an aluminum fixture via a vacuum.

### RELATED APPLICATIONS

This regular utility non-provisional patent application claims priority benefit of earlier-filed U.S. Provisional Patent Application Ser. No. 63/649,523, filed on May 20, 2024, and entitled “LASER WELDING SYSTEM AND METHOD”. The identified earlier-filed provisional patent application is hereby incorporated by reference in its entirety into the present patent application.

### STATEMENT REGARDING FEDERALLY-SPONSORED RESEARCH OR DEVELOPMENT

This invention was made with Government support under Contract No.: DE-NA-0002839 awarded by the United States Department of Energy/National Nuclear Security Administration. The Government has certain rights in the invention.

### BACKGROUND

Laser welding with a blue wavelength is sometimes used to weld tabs or other simple geometries requiring basic fixturing. For example, blue laser welding wire, pins, and general bulk material is increasingly common.

Welding foils together may be accomplished via other processes. For example, green laser welding is known. This is limited in capability due to an energy density capable of welding to the supporting fixture. A resistance seam welder is also known but is limited to welding straight shapes or spots.

Regardless of the welding process, using aluminum in welding fixture structures is a common practice but not as a direct-contact backing support. For example, known welding processes use aluminum and/or steel fixtures with mechanical clamping.

### SUMMARY

The present invention solves the above problems and other problems by presenting welding systems and methods that allow for versatile welding paths and more effective welding fixtures.

An embodiment of the present invention is a method of welding first and second foils together. The method includes a step of positioning the first and second foils on a lower section of an aluminum fixture. The method further includes a step of compressing the first and second foils together over a first ridge of the lower section via an upper section of the aluminum fixture thereby defining a first weld location coinciding with the first ridge. The method further includes a step of activating a laser along the first weld location thereby welding the first and second foils together such that the aluminum fixture remains unwelded.

Another embodiment is a method of welding first and second foils together. The method includes a step of positioning the first and second foils on an aluminum fixture. The method further includes a step of inducing a vacuum between the first and second foils thereby compressing the first and second foils together over a first ridge of the aluminum fixture and defining a first weld location coinciding with the first ridge. The method further includes a step of activating a laser along the first weld location thereby welding the first and second foils together such that the aluminum fixture remains unwelded.

Yet another embodiment is a system for welding first and second foils together. The system includes an aluminum fixture and a blue or green wavelength laser. The aluminum fixture includes a lower section and an upper section. The lower section has first and second ridges spaced apart from each other. The upper section is configured to be positioned near the lower section and includes first and second outer members and first and second inner members. The outer members are spaced apart from each other so that the ridges are positioned between the outer members when the upper section is positioned near the lower section. The inner members are spaced apart from each other and positioned between the outer members so that the first ridge is positioned between the first outer member and the first inner member and the second ridge is positioned between the second outer member and the second inner member when the upper section is positioned near the lower section. The first outer member and the first inner member are configured to compress the foils together against the first ridge to form a first weld location. The second outer member and the second inner member are configured to compress the foils together against the second ridge to form a second weld location. The laser is configured to weld the foils together at the weld locations such that the lower section draws heat from the weld locations via the ridges.

Another embodiment of the present invention is a system for welding first and second foils together. The system includes an aluminum fixture, a vacuum device, and a blue or green wavelength laser. The aluminum fixture includes first and second sets of vacuum perforations spaced from each other and first and second ridges spaced apart from each other and positioned between the sets of vacuum perforations. The vacuum device is configured to induce a vacuum between the foils thereby compressing the foils together against the first ridge to form a first weld location and against the second ridge to form a second weld location. The laser is configured to weld the foils together at the weld locations such that the aluminum fixture draws heat from the weld locations via the ridges.

### BRIEF DESCRIPTION OF THE DRAWING FIGURES

Embodiments of the present invention are described in detail below with reference to the attached drawing figures, wherein:

FIG. 1 is a perspective view of a welding system constructed in accordance with an embodiment of the invention;

FIG. 2 is a foil welded according to an embodiment of the invention;

FIG. 3 is a graphical representation of absorptivity of various materials for different welding laser wavelengths;

FIG. 4 is a flow diagram of certain method steps in accordance with another embodiment of the invention;

FIG. 5 is an end elevation view of a welding system constructed in accordance with another embodiment of the invention; and

FIG. 6 is a flow diagram of certain method steps in accordance with another embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

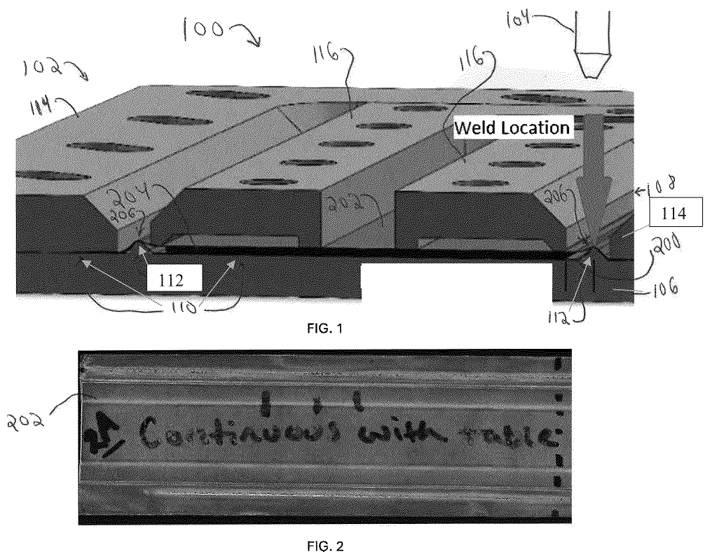

Turning initially to FIGS. 1-3, a foil welding system 100 constructed in accordance with an embodiment of the invention is illustrated. The system 100 broadly comprises a fixture 102 and a laser 104. This invention will be described in terms of welding two foils 200, 202 together, although three or more foils may be welded together. The foils 200, 202 may be highly reflective red metal foils such as copper or gold. Such materials can be welded via blue laser wavelength or green laser wavelength. Any other suitable material that can be welded via a chosen laser wavelength without the underlying fixture also being welded may be used. To that point, other laser wavelengths besides blue or green may be used. The foils 200, 202 may be welded together to at least partially enclose a material, a component, or a device such as an electronic cable. The foils 200, 202 may shield, protect, or cover the enclosed material, component, or device. An exemplary application includes welding the foils 200, 202 together to enclose material 204 to form a shielded cable. The invention is applicable to foils welded with and without material or a component or device enclosed inside.

The fixture 102 supports the foils 200, 202 and may include a lower section 106 and an upper section 108. Importantly, the fixture 102 may be formed of aluminum or any other suitable material that is reflective of wavelengths that the foils 200, 202 absorb. The fixture 102 may allow an offset, such as approximately 0.070 inches, for weld placement, with material 204 to be sandwiched by the foils 200, 202 between the ridges described below. Other offset values may be used depending on the application.

The lower section 106 supports the foils 200, 202 from below and may include planar regions 110 and spaced apart first and second ridges 112. The lower section 106 may include structure or geometry for anchoring the upper section 108 thereto.

The planar regions 110 support or receive portions of the foils 200, 202 that are not being welded together. The planar regions 110 may coincide or be aligned with portions of the upper section 108.

The ridges 112 urge portions of the lower foil 200 against the upper foil 202 at first and second weld locations 206. To that end, the ridges 112 protrude from lower section 106 in any shape desired to weld. Ridges 112 coincide to the weld path of the laser 104.

The upper section 108 presses portions of the upper foil 202 toward the planar regions 110 of the lower section 106 so that portions of the upper foil 202 contact the lower foil 200 at the weld locations 206. To that end, the upper section 108 may include outer members 114 and inner members 116. Both may not be required depending on the application. The upper section 108 may also include structure or geometry for anchoring the upper section 108 to the lower section 106.

The outer members 114 may be positioned laterally outside of the ridges 112. The outer members 114 may press the foils 200, 202 together against the lower section 106.

The inner members 116 may be spaced from the planar regions 110 of the lower section 106 so that the upper foil 202 is pressed against the lower foil 200 over the ridges 112 at the weld locations 206 but not over the planar region 110 between the ridges 112. That is, the inner members 116 may allow a gap between the foils 200, 202 over the planar region 110 laterally between the ridges 112. Gaps between foils 200, 202 cannot be present at the peak of 112 ridges where welding occurs.

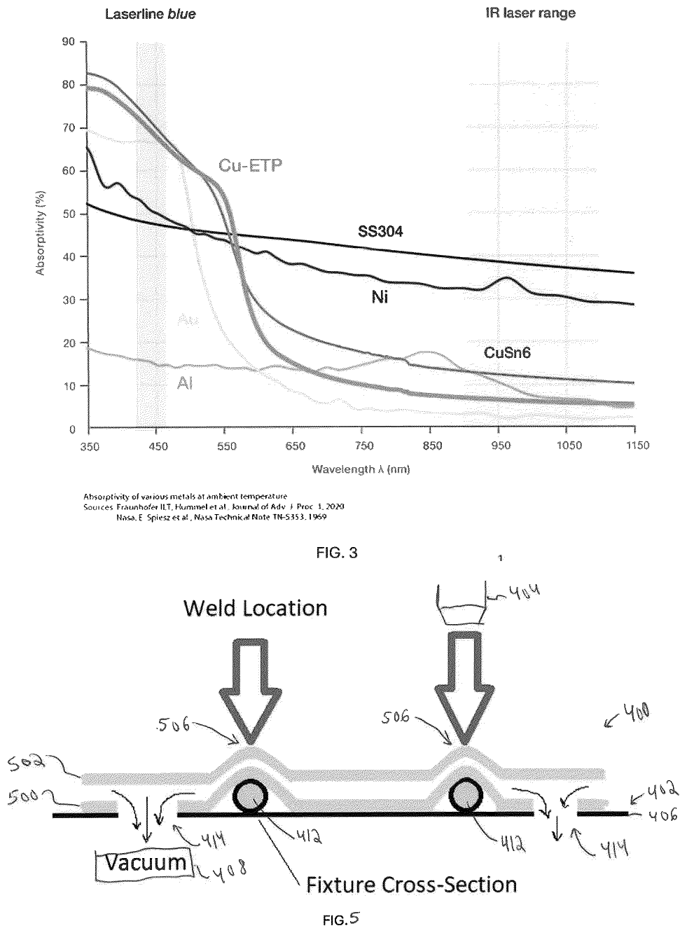

The laser 104 may be configured to emit a welding beam toward the weld locations 206 and may be a blue wavelength with enough laser power density to weld the foils 200, 202 together but not enough power density to weld the foils 200, 202 to the aluminum fixture 102. In another embodiment, green wavelength may be used. See FIG. 3.

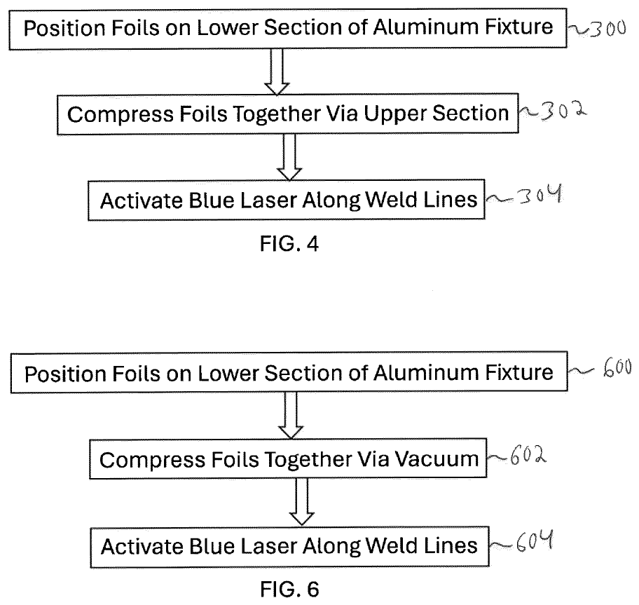

Turning to FIG. 4, use of the system 100 will now be described. First, the foils 200, 202 may be placed on the lower section 106 with the material 204 between the foils 200, 202 as shown in block 300. The upper section 108 may then be secured over the foils 200, 202 so that the foils 200, 202 are compressed together over the ridges 112 with the weld locations 206 being exposed, as shown in block 302. The ridges 112 provide tension on the foils 200, 202 to remove any gap therebetween. The laser 104 may then be activated along the weld locations 206 thereby welding the foils 200, 202 together but not welding the aluminum fixture 102, as shown in block 304. The ridges 112 aid in extracting heat from the foils 200, 202 reducing the likelihood of material 204 damage.

The above-described invention provides several advantages. The aluminum fixture 102 is broadly reflective whereas red metals more effectively absorb blue or green light. Welding copper or gold (red metal) foils via blue or green laser wavelength takes advantage of the reflectivity of the aluminum while the foils 200, 202 absorb the energy. Other benefits include heat extraction by the aluminum fixture 102 and a cost-effective fixture 102.

The present invention is also useful because when laser welding thin foils, it may be critical to fixture components tightly together to remove any gap between the two materials to be welded. By using the aluminum fixture 102, blue or green laser wavelength generates enough laser energy density to weld the copper or gold foils together but not enough laser energy density to weld the aluminum directly underneath the foils. This allows safe welding completely through both foils without the risk of welding to the fixture underneath the foils. The aluminum also effectively extracts heat from the weld region which aids in weld consistency and results in less heat input to critical neighboring components.

The present invention allows welding of unique foil shapes using blue or green laser wavelength with consistent results. Many flat-flex cables components with a cable sandwiched or enclosed by a shield may utilize this invention and achieve valid acceptance rates and high throughput. The present invention provides higher acceptance rates than GLW and RSW methods. This invention allows welding of complex shapes and multiple parts at once with processing rates approximately 1000 times faster than current known offerings.

Potential applications include cable welding, heat shielding using gold foils, and unique circuitry needing conductive foils, among others. Potential industries may include aerospace, defense, microelectronics, and batteries, among others.

Turning to FIG. 5, a foil welding system 400 constructed in accordance with an embodiment of the invention is illustrated. The system 400 broadly comprises a fixture 402, a vacuum device 408, and a laser 404. This invention will be described in terms of welding two foils 500, 502 together, although three or more foils may be welded via this invention. An exemplary application includes welding shields for flat-flex cables such as cable 504.

The foils 500, 502 may be highly reflective red metal foils such as copper or gold. Such materials can be welded via blue or green laser wavelength.

The fixture 402 supports the foils 500, 502 and may include a lower section 406. Importantly, the fixture 402 may be formed of aluminum or any other suitable material that is reflective of wavelengths that the foils 500, 502 absorb. The fixture 402 may allow a small offset, such as approximately 0.070 inches, for the cable 504 to be sandwiched by the foils 500, 502 between the ridges described below.

The lower section 406 supports the foils 500, 502 from below and may include planar regions 410, spaced apart ridges 412, and vacuum perforations 414. The lower section 406 may include structure or geometry for being anchored to a table or base.

The planar regions 410 support or receive portions of the foils 500, 502 that are not being welded together. The planar regions 410 may include the aforementioned vacuum perforations 414.

The ridges 412 urge portions of the lower foil 500 against the upper foil 502 at weld locations 206. To that end, the ridges 412 extend longitudinally generally parallel to each other.

The vacuum perforations 414 may be holes in the lower section 406 which (in conjunction with openings in the lower foil 500) expose an interior volume between the foils 500, 502 to the vacuum device 408. The vacuum perforation 414 may be positioned in the planar regions 410 laterally outside the ridges 412 so that air is drawn from the interior volume between the ridges 412, over the ridges 412, and out the vacuum perforations 414.

The vacuum device 408 may be connected to the vacuum perforations 414 for drawing air from the interior volume between the foils 500, 502. The vacuum device 408 may be a vacuum table that draws air from the structure (in this case fixture 402 and foils 500, 502) positioned on it. The vacuum device 408 may include valves and controls for precisely dictating airflow and pressure.

The laser 404 may be configured to emit a welding beam toward the weld locations 506 and may be a blue or green wavelength with enough laser power density to weld the foils 500, 502 together but not enough power density to weld the foils 500, 502 to the lower section 406.

Turning to FIG. 6, use of the system 400 will now be described. First, the foils 500, 502 may be placed on the lower section 406, as shown in block 600. The vacuum device 408 may then secure the foils 500, 502 to the lower section 506 so that the foils 500, 502 are compressed together over the ridges 412 with the weld locations 506 being exposed, as shown in block 602. Specifically, the vacuum device 408 may draw air from between the foils 500, 502 through the vacuum perforations 414, thus allowing ambient air pressure to compress the foils 500, 502 against the ridges 412. The ridges 412 provide tension on the foils 500, 502 to remove any gap therebetween. The laser 404 may then be activated along the weld locations 506 thereby welding the foils 500, 502 together but not welding the aluminum fixture 402, as shown in block 604. The ridges 412 provide heat extraction from the foils 500, 502.

In addition to the aforementioned advantages, the present invention allows welding more complex foil shapes with increased reliability, reduced process complexity, and less potential for damage. In other words, this allows welding of foils without the need for complicated top-side fixturing, reducing complexity and potential for damage to the top exposed layer. This streamlines processing time and more easily allows multiple parts to be welded at once. The present invention also eliminates pre-weld and post-weld operations to remove and reattach the parts as panels.

### ADDITIONAL CONSIDERATIONS

This description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. This description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods may be illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises”, “comprising”, “includes”, “including”, “has”, “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 114 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method of welding first and second foils together, the method comprising:
positioning the first and second foils on a lower section of an aluminum fixture;
compressing the first and second foils together over a first ridge of the lower section via an upper section of the aluminum fixture thereby defining a first weld location coinciding with the first ridge;
activating a laser along the first weld location to weld the first and second foils together such that the aluminum fixture remains unwelded.

2. The method of claim 1, further comprising a step of positioning a cable between the first and second foils so that the first and second foils sandwich the cable.

3. The method of claim 2, further comprising steps of:
compressing the first and second foils together over a second ridge spaced from the first ridge via the upper section; and
activating the laser along the second weld location so that the first and second foils cooperatively encircle the cable.

4. The method of claim 3, wherein the upper section includes at least two outer members and an inner member, the first and second ridges of the lower section being positioned between the at least two outer members, the inner member being positioned between the first and second ridges.

5. The method of claim 4, wherein the inner member is vertically spaced from the lower section during the compressing steps to accommodate the cable.

6. The method of claim 3, wherein the upper section includes at least two outer members and at least two inner member, the first and second ridges of the lower section being positioned between the at least two outer members, the at least two inner member being positioned between the first and second ridges, each of the lower section and the upper section having lateral symmetry.

7. The method of claim 1, wherein each foil is made of copper or gold.

8. The method of claim 1, wherein the laser has a blue wavelength.

9. The method of claim 1, wherein the laser has a green wavelength.

10. A method of welding first and second foils together, the method comprising:
positioning the first and second foils on an aluminum fixture;
inducing a vacuum between the first and second foils thereby compressing the first and second foils together over a first ridge of the aluminum fixture and defining a first weld location coinciding with the first ridge;
activating a laser along the first weld location to weld the first and second foils together such that the aluminum fixture remains unwelded.

11. The method of claim 10, wherein the aluminum fixture includes a plurality of vacuum perforations for inducing the vacuum therethrough.

12. The method of claim 10, wherein the first ridge is positioned between the vacuum perforations.

13. The method of claim 12, wherein the inducing step includes inducing the vacuum between the first and second foils thereby compressing the first and second foils over a second ridge spaced from the first ridge, the second ridge being positioned between the vacuum perforations.

14. The method of claim 10, further comprising a step of positioning a cable between the first and second foils so that the first and second foils sandwich the cable.

15. The method of claim 14, the inducing step further including inducing the vacuum between the first and second foils thereby compressing the first and second foils together over a second ridge spaced from the first ridge, the method further comprising a step of:
activating the laser along the second weld location so that the first and second foils cooperatively encircle the cable.

16. The method of claim 10, wherein each foil is made of copper or gold.

17. The method of claim 10, wherein the laser has a blue wavelength.

18. The method of claim 10, wherein the laser has a green wavelength.

19. A system for welding first and second foils together, the system comprising:
an aluminum fixture including:
a lower section having first and second ridges spaced apart from each other; and
an upper section configured to be positioned near the lower section, the upper section having:
first and second outer members spaced apart from each other so that the first and second ridges are positioned between the first and second outer members when the upper section is positioned near the lower section; and
first and second inner members spaced apart from each other and positioned between the first and second outer members so that the first ridge is positioned between the first outer member and the first inner member and the second ridge is positioned between the second outer member and the second inner member when the upper section is positioned near the lower section,
wherein the first outer member and the first inner member are configured to compress the first and second foils together against the first ridge to form a first weld location and the second outer member and the second inner member are configured to compress the first and second foils together against the second ridge to form a second weld location; and
a blue or green wavelength laser configured to weld the first and second foils together at the first weld location and the second weld location such that the lower section draws heat from the first and second weld locations via the first and second ridges.

20. A system for welding first and second foils together, the system comprising:
an aluminum fixture including:
first and second sets of vacuum perforations spaced from each other; and
first and second ridges spaced apart from each other and positioned between the first and second sets of vacuum perforations;
a vacuum device configured to induce a vacuum between the first and second foils thereby compressing the first and second foils together against the first ridge to form a first weld location and against the second ridge to form a second weld location; and
a blue or green wavelength laser configured to weld the first and second foils together at the first weld location and the second weld location such that the aluminum fixture draws heat from the first and second weld locations via the first and second ridges.
